(19) United States
(12) Patent Application Publication
(10) Pub. No.: US 2006/0046953 A1
(43) Pub. Date: Mar. 2, 2006

(54) Process for inhibiting scale on metal surfaces

(76) Inventors: Kostan B. Charkhutian, Westwood, NJ (US); Bruce L. Libutti, Teaneck, NJ (US); Michael Andrew Murphy, Holmewood (GB)

Correspondence Address: David L. Hedden;Ashland Inc., P.O. Box 2219, Columbus, OH, 43216, US

(21) Appl. No.: 10/932,917

(22) Filed: Sep. 2, 2004

(51) Int. Cl. C11D 3/33

(52) U.S. Cl. 510/480

(57) ABSTRACT

This invention relates to a process for inhibiting scale on metal surfaces exposed to an aqueous system, particularly a circulating aqueous system. The process comprises adding ethylenediamine-N,N-disuccinic acid, or salts thereof, to the aqueous system. Ethylenediamine-N,N-disuccinic acid, or salts thereof, act as a chelating agent and are biodegradable. The process is useful for inhibiting the formation of scale on metal surfaces of steam generating and cooling systems.

### FIELD OF THE INVENTION

This invention relates to a process for inhibiting scale on metal surfaces exposed to an aqueous system, particularly a circulating aqueous system. The process comprises adding ethylenediamine-N,N-disuccinic acid, or salts thereof, to the aqueous system. The process is useful for inhibiting the formation of scale on metal surfaces of steam generating and cooling systems.

### BACKGROUND OF THE INVENTION

Divalent and trivalent cations, e.g. calcium, magnesium, iron and copper, are often found in the water, which circulates in various heating and cooling systems, for example chillers, boilers, and process heat exchangers. Typically, the heating and cooling system is comprised of components or equipment made of metal such as iron, steel, aluminum, etc.

The divalent and trivalent metal cations often form a precipitate in the presence of anions, e.g. sulfate, carbonate, silicate, and hydroxide found in the water, and form scale on the metal surfaces of the parts of the heating and cooling system.

It is known to add salts of ethylenediaminetetraacetic acid (EDTA) and nitrilotriacetic acid (NTA) to the water circulating through heating and cooling systems. These salts react with the divalent and trivalent cations to form soluble, thermally stable complexes, which reduce or eliminate the formation of scale and fouling on the metal surface of the metal components and equipment used in the heating and cooling systems. In steam generating systems, the complexed cations include calcium, magnesium, iron and copper.

There are problems with using the salts of ethylenediaminetetraacetic acid (EDTA) and nitrilotriacetic acid (NTA) in aqueous systems to chelate metal cations. Regulations in Europe require that the blowdown of boiler water must contain materials that are readily biodegradable. Thus, EDTA is not acceptable since it is not biodegradable. Although NTA is biodegradable, it is classified as a carcinogen in the United States. There is an interest in discovering biodegradable materials that are thermally stable, yet have anti-precipitation capabilities comparable to EDTA, when used in a heating or cooling system where the circulating water contains calcium, magnesium and/or iron cations.

The trisodium salt of ethylenediamine-N,N-disuccinic acid is a known compound and is sold under the trademark OCTAQUEST® E 30. The patent literature discloses the use of this material for stripping heavy metals from industrial wastewaters and polluted soils.

All citations referred to in this application are expressly incorporated by reference.

### BRIEF SUMMARY OF THE INVENTION

This invention relates to a process for inhibiting scale on metal surfaces exposed to an aqueous system, particularly a circulating aqueous system. The process comprises adding ethylenediamine-N,N-disuccinic acid, or salts thereof, to the aqueous system. The process is useful for inhibiting the formation of scale, particularly calcium and magnesium scale, on metal surfaces of steam generating and cooling system

It was discovered that the biodegradable and non-carcinogen ethylenediamine-N,N-disuccinic acid trisodium salt has some thermal stability. Experiments indicate that it is similar in effectiveness to EDTA salts in chelating calcium and magnesium ions, even at high pressures, i.e. at 450 psig

The process is particularly useful for inhibiting the formation of scale on metal surfaces of industrial, commercial and institutional water systems operating at temperatures of 120° C. to 235° C. and pressures up to 750 psig, preferably up to pressures of 450 psig (31 bar).

### DETAILED DESCRIPTION OF THE INVENTION

The detailed description and examples will illustrate specific embodiments of the invention will enable one skilled in the art to practice the invention, including the best mode. It is contemplated that many equivalent embodiments of the invention will be operable besides these specifically disclosed.

Although ethylenediamine-N,N-disuccinic acid, or salts thereof, can be used in the process, preferably used is ethylenediamine-N,N-disuccinic acid trisodium salt, which is represented by the following structural formula:

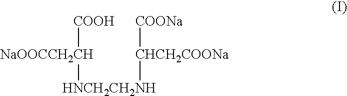

The ethylenediamine-N,N-disuccinic acid, or salt thereof, is added to an aqueous system such as cooling water, boiler feed water, boiler water, reverse osmosis and geothermal/mining water in amounts from 1 to 500 ppm, but preferably from 10 to 50 ppm.

The process is particularly useful for aqueous systems circulating through boilers made of steel, although the process is useful for aqueous systems circulating through equipment made of other metals, e.g. iron, aluminum, brass, copper, and alloys thereof.

The ethylenediamine-N,N-disuccinic acid, or salt thereof, may be combined with other components used in scale inhibitor compositions, e.g. corrosion inhibitors, oxygen scavengers, surfactants, dispersants, precipitants, antifoams or agents that inhibit microbiological growth.

Abbreviations:

BWT A BWT A (boiler water treatment) contains 9.3% EDDS, 1.5% carboxylic dispersants, 1.3% NaOH, 1.25% sodium erythorbate, and balance is water.
EDDS is trisodium salt of ethylenediamine-N,N-disuccinic acid, which is available as OCTAQUEST E-30, which is a 37% solution in water.

### EXAMPLES

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated.

Several solutions based on EDDS were prepared. The formulations are set forth as follows:
1. Without cations: 1650 ppm BWTA that contained EDDS without cations.
2. Calcium cation only: 1650 ppm BWTA that contained EDDS with 43 ppm calcium (as CaCO₃).
3. Magnesium cation only: 7700 ppm BWTA that contained EDDS with 252 ppm magnesium (as CaCO₃).
4. Iron cation only: 1100 ppm BWTA that contained EDDS with 16 ppm iron (as Fe).
5. All three cations: 10450 ppm BWTA that contained EDDS with 43 ppm calcium (as CaCO₃), 252 ppm magnesium (as CaCO₃) and 16 ppm iron (as Fe).

The solutions were prepared by mixing the components. The mixtures were autoclaved for three hours at 420° F./216° C. (300 psig/˜21 bar) in one case and 456° F./236° C. (450 psig/˜31 bar) in another case to determine effectiveness of using EDDS at different pressures and temperatures.

High levels of calcium and magnesium were used due to the solubility limits of their carbonate and hydroxide respectively. All solutions were adjusted to pH: 9.95-10.05 using diluted caustic soda.

The autoclaved samples were analyzed for calcium, magnesium, and iron using ICP. ICP is Inductively Coupled Plasma. Thermal stability was measured by colorimetric titration using copper as a titrant. Complexing ability was measured by determination of metal ions retained in solution by ICP. Filtration was done using 0.45-micron filters. Filtration was done before samples were submitted for thermal stability and complexing ability testing. Filtration was done to remove the uncomplexed cations, which precipitated, and the measure of success was determined on the amount materials held in solution.

TABLE I
(TOTAL CHELANT THERMAL STABILITY EDDS AT
DIFFERENT PRESSURES/TEMPERATURES)

Pressure/Temperature

| Cation(s) | 300 psig (˜21 bar)/ | 450 psig (˜31 bar)/ |
|---|---|---|
| in solution | 216° C. | 235° C. |
| No cations | ˜38% survived | ˜20% survived |
| Calcium only | ˜56% survived | ˜52% survived |
| Magnesium only | ˜45% survived | ˜46% survived |
| Iron only | INTR¹ | INTR¹ |
| All three cations | ˜67% survived | ˜63% survived |

¹Unable to analyze due to interference by iron

The data in Table I show how much of the EDDS survived after it was subjected to the pressures and temperatures set forth in Table I. Higher percentages of survival indicate that the EDDS was more thermally stable.

The data indicate that EDDS had some thermal stability both in the absence and the presence of the cations. The data further show that the thermal stability did not decrease appreciably as pressure and temperature increased.

TABLE II
(ANTIPRECIPITATION EFFECT OF EDDA
AT DIFFERENT PRESSURES)

| | Pressure/Temperature | |
|---|---|---|
| Cation(s) | 300 psig (˜21 bar)/ | 450 psig (˜31 bar)/ |
| in solution | 216° C. | 235° C. |
| Calcium only | Almost 100% remained | ˜64% remained |
| Magnesium only | ˜46% remained | ˜42% remained |
| Iron only | ˜24% remained | <10% remained |
| All three cations | | |
| Calcium | ˜85% remained | Almost 100% remained |
| Magnesium | ˜96% remained | ˜78% remained |
| Iron | ˜44% remained | ˜38% remained |

The higher the percentage of cations remaining in solution, the better the complexing agent, because the cations are not as likely to form scale on metal surfaces if they remain in solution. The data indicate that EDDS complexes at least a portion of all the cations tested at lower and higher pressures and temperatures. The data further indicate that EDDS is more effective in complexing calcium and magnesium than iron.

We claim:

1. A process for inhibiting scale formation and fouling on a metal surface exposed to an aqueous system, which comprises
adding an effective scale inhibiting amount of ethylenediamine-N,N-disuccinic acid, or salts thereof, to said aqueous system.

2. The process in claim 1 wherein a salt of ethylenediamine-N,N-disuccinic acid is used and the salt is the tetrasodium salt.

3. The process of claim 1 wherein the aqueous system contains calcium cations and the metal surface is subjected to pressures ≦450 psi.

4. The process of claim 3 wherein metal surface is the metal surface of a boiler.

5. The process of claim 4 wherein the metal surface of the boiler is steel.

6. The process of claim 5 wherein the boiler operates at a temperature of at least 120° C.

7. The process of claim 1, 2, 3, 4, 5, or 6 wherein the concentration of ethylenediamine-N,N-disuccinic acid, or salt thereof, is from 1 ppm to 500 ppm.

8. The process of claim 7 wherein the concentration of ethylenediamine-N,N-disuccinic acid, or salt thereof, is from 10 ppm to 50 ppm.
